(19) United States
(12) Patent Application Publication
(10) Pub. No.: US 2016/0150285 A1
(43) Pub. Date: May 26, 2016

(54) ELECTRONIC PROGRAM GUIDE WITH ON-DEMAND CROSS-REFERENCES

(71) Applicant: Time Warner Cable Enterprises LLC, New York, NY (US)

(72) Inventors: Jay Thomas, Denver, CO (US); Frederic Regis, Denver, CO (US); Ryan Lawrence Holcombe, Thornton, CO (US)

(21) Appl. No.: 14/554,236

(22) Filed: Nov. 26, 2014

(51) Int. Cl. H04N 21/482; H04N 21/472; H04N 21/2187

(52) U.S. Cl. CPC H04N 21/482; H04N 21/2187; H04N 21/47202

(57) ABSTRACT

A method for facilitating an enhanced electronic program guide with on-demand cross-references includes the steps of: obtaining, by a controller, a first set of information regarding live broadcast assets; obtaining, by the controller, a second set of information regarding on-demand assets; comparing, by the controller, the first and second sets of information to determine whether at least a given one of the live broadcast assets has a matching on-demand asset; and placing a visual indication associated with a listing of the given one of the live broadcast assets on a corresponding electronic program guide. The visual indication is indicative of the given one of the live broadcast assets having a matching on-demand asset.

### FIELD OF THE INVENTION

The present invention relates generally to content networks and other communications networks, and, more particularly, to electronic program guides (EPGs).

### BACKGROUND OF THE INVENTION

In a broadcast media environment, electronic program guides (EPGs) provide users of television, radio, and other media applications with continuously updated on-screen menus displaying broadcast programming or scheduling information relating to current and upcoming programming. An EPG is essentially the modern equivalent of the television listings traditionally printed in a local newspaper or TV magazine.

Interactive program guides (IPGs), a sub-class of EPGs, are nearly pervasive in most modern broadcast media. EPGs can be made available through television (e.g., on set-top boxes), mobile phones, and on the Internet. Digital television technology allows local broadcasters to transmit program-guide information to a digital television (or set-top box) along with regular programming content. Digital television brings electronic program guides—already familiar to many cable viewers—to households that rely on over-the-air broadcasts.

One feature of an EPG most appreciated by users is its graphical user interface (GUI), typically consisting of a grid or table listing channel names and program titles and times; web and television-based IPG interfaces allow the user to select any given program listing for an available channel and display additional information about the program supplied by the IPG provider. Typical IPGs also allow users the ability to navigate through the IPG listings using selected search criteria such as genre, time, title, etc., as well as providing immediate one-touch access to, or recording of, a selected program.

Standards for delivery of scheduling information to television-based EPGs vary from application to application. Older television EPGs relied on analog technology to distribute listings data to EPG-enabled consumer receiving equipment. For digital television, the European Telecommunications Standards Institute (ETSI) published standard ETS 300 707, the disclosure of which is incorporated herein by reference in its entirety, to standardize the delivery of EPG data over digital television broadcast signals. Listings data for EPGs integrated into digital terrestrial television and radio receivers of the present day is typically sent within each station's MPEG transport stream, or alongside it in a special data stream.

### SUMMARY OF THE INVENTION

Principles of the present invention provide an electronic program guide (EPG) with on-demand content (e.g., video-on-demand (VOD)) cross-references. More particularly, one or more embodiments provide a mechanism for seamlessly integrating live broadcast (e.g., television) content with on-demand content via an enhanced EPG.

In one aspect, an exemplary method includes the steps of obtaining, by a controller, a first set of information regarding live broadcast assets from a first database in operative communication with the controller; obtaining, by the controller, a second set of information regarding on-demand assets from a second database in operative communication with the controller; comparing, by the controller, the first and second sets of information to determine whether at least one of the live broadcast assets has a matching on-demand asset; and placing a visual indication associated with a listing of the at least one of the live broadcast assets on a corresponding electronic program guide, the visual indication being indicative that the at least one of the live broadcast assets has a matching on-demand asset.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., set top box and/or server) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein. The means do not include a transmission medium per se or a disembodied signal per se.

Techniques of the present invention can provide substantial beneficial technical effects. For example, one or more embodiments provide one or more of:
Ability to manage live broadcast content and on-demand content through a single user interface;
Ability to allow viewers to determine whether content appearing in live program listings is available on demand to thereby control when desired program content is viewed;
Ability to restart a selected live broadcast program which is already in progress either from the beginning or from a prescribed starting point through the EPG when the program is available on demand;
Ability to immediately start a selected live broadcast program which is scheduled to air at some future time through the EPG when the program is available on demand;
Ability to add a program to a personalized watch list, making the program easier to find and watch in the future;
Ability to set a reminder timer on an asset, reminding the user about the availability of the program at a specified time in the future.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head-end such as that of FIG. 3;

FIG. 6 is a functional block diagram of an exemplary centralized CPE unit, useful within the system of FIG. 1;

FIG. 7 is a functional block diagram depicting at least a portion of an illustrative system for generating an enhanced EPG with on-demand cross-references, according to an embodiment of the invention;

FIG. 8 is a flow diagram depicting at least a portion of an exemplary program selection method, according to an embodiment of the invention;

FIG. 9 is a screen shot conceptually depicting an exemplary EPG 900 with on-demand cross-references, according to an embodiment of the invention;

FIG. 10 conceptually depicts an exemplary Entertainment Identifier Registry (EIDR) identifier, suitable for use in conjunction with one or more embodiments of the invention;

FIG. 11 conceptually depicts one way in which EIDR may be used to enable scalable content services, which is suitable for use in conjunction with one or more embodiments of the invention; and

FIG. 12 is a block diagram of a computer system useful in connection with one or more aspects of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Purely by way of example only and without limitation, embodiments of the invention will be shown in the context of a cable multi-service operator (MSO) providing data and voice services as well as entertainment services. However, one or more embodiments are broadly applicable to any broadband network, non-limiting examples of which include an Internet Protocol (IP) network, fiber-to-the-curb (FTTC) or fiber-to-the-premises (FTTP) network, wireless broadband, and the like. Specifically, one or more embodiments of the invention are directed to an electronic program guide (EPG) configured to allow seamless integration of live broadcast (e.g., television) content with on demand content (e.g., video-on-demand (VOD)). It should be understood, however, that embodiments of the invention are not limited to the system, methods and/or apparatus shown and described herein. Rather, it will become apparent to those skilled in the art given the teachings herein that numerous modifications can be made to the illustrative embodiments shown that are within the scope of the claimed invention. That is, no limitations with respect to the embodiments shown and described herein are intended or should be inferred.

As previously noted, IP-based data services (and, for that matter, Internet Protocol television (IPTV)) may be provided over a variety of networks. Purely by way of example and not limitation, some embodiments will be shown in the context of a cable multi-service operator (MSO) providing data services as well as entertainment services. In one or more embodiments, an MSO provides an EPG configured to seamlessly integrate live broadcast listings with on demand content listings to provide viewers with enhanced control over desired programming content. Note that one or more embodiments are applicable to traditional cable television using QAMs, to other kinds of video content networks (e.g., fiber optic) and/or to IPTV delivered over any kind of IP network to any kind of IP device (a gaming console is one non-limiting example of a device that facilitates viewing IPTV)—wherever both broadcast content and video on demand (VOD) are available.

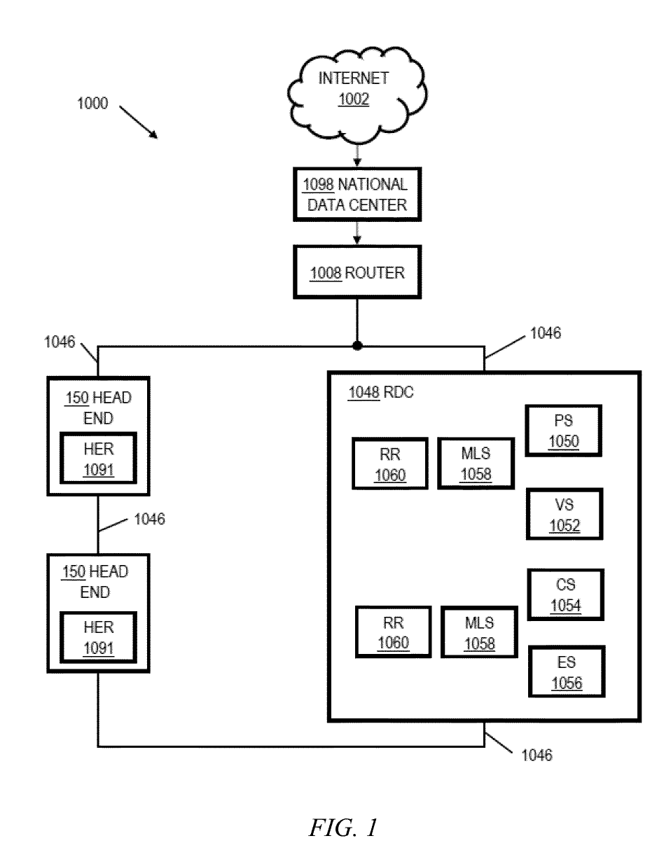

FIG. 1 is a block diagram depicting at least a portion of an exemplary system 1000, according to an aspect of the invention. System 1000 includes a regional data center (RDC) 1048, and one or more divisions, represented by division head-ends 150. RDC 1048 and head-ends 150 are interconnected by a network 1046; by way of example and not limitation, a dense wavelength division multiplex (DWDM) network. Elements 1048 and 150 on network 1046 may be operated, for example, by or on behalf of a cable MSO, and may be interconnected with a global system of interconnected computer networks that use the standardized Internet Protocol Suite (TCP/IP)(transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, Calif., USA.

Head-ends 150 may each include a head-end router (HER) 1091 which interfaces with network 1046. Head-end routers 1091 are omitted from figures below merely for economy of description. This does not imply that head-end routers 1091 are not present in a commercial implementation of one or more embodiments of the invention.

RDC 1048 may include one or more provisioning servers (PS) 1050, one or more video servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head-ends and/or regional data centers. For example, such an NDC might include one or more VOD servers; switched digital video (SDV) functionality; gateways to obtain content (e.g., program content) from various sources including cable feeds and/or satellite; and so on.

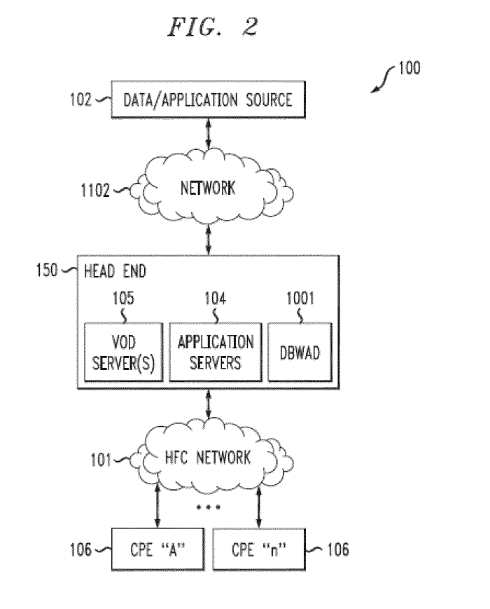

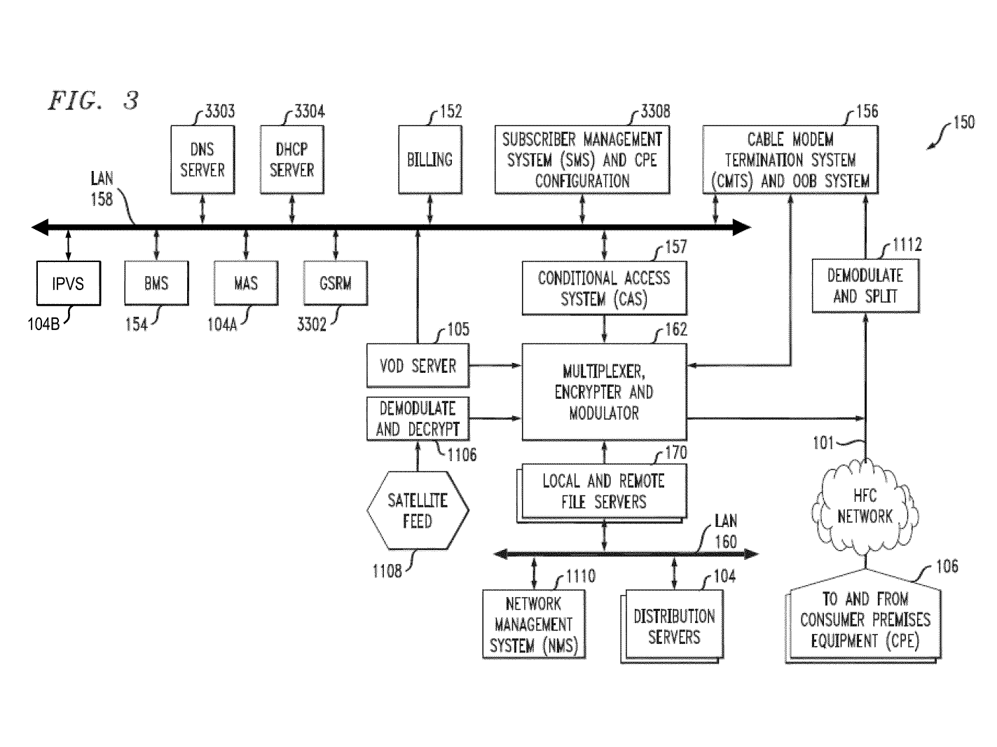

FIG. 2 is a functional block diagram illustrating at least a portion of an exemplary content-based (e.g., hybrid fiber-coaxial (HFC)) divisional network 100, useful within the system of FIG. 1. See, for example, U.S. Patent Application Publication No. 2006/0130107 of Gonder et al., entitled “Method and Apparatus for High Bandwidth Data Transmission in Content-based Networks,” the complete disclosure of which is expressly incorporated by reference herein in its entirety for all purposes. The various components of the network 100 include: (i) one or more data and application origination points 102; (ii) one or more application distribution servers 104; (iii) one or more VOD servers 105; and (v) consumer premises equipment or customer premises equipment (CPE) 106. The distribution server(s) 104, VOD servers 105 and CPE(s) 106 are connected via a bearer (e.g., HFC) network 101. Servers 104, 105 can be located in head-end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

The data/application origination point 102 comprises any medium that allows data and/or applications (such as a VOD-based or “Watch TV” application) to be transferred to a distribution server 104, for example, over network 1102. This can include for example a third party data source, application vendor website, compact disk read-only memory (CD-ROM), external network interface, mass storage device (e.g., Redundant Arrays of Inexpensive/Independent Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head-end 150, HFC network 101, and CPEs 106 thus represent the divisions which were represented by division head-ends 150 in FIG. 1.

The application distribution server 104 comprises a computer system where such applications can enter the network system. Distribution servers per se are well known in the networking arts, and accordingly will not be described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other appropriate locations) that can be accessed by a distribution server 104 or a cable modem termination system 156 (discussed below with regard to FIG. 3). Non-limiting examples of CPE are set-top boxes (STBs), game consoles, IP video streaming boxes, Internet-connected TVs and high-speed cable modems for providing high bandwidth Internet access in premises such as homes and businesses.

Also included (for example, in head-end 150) is a dynamic bandwidth allocation device (DBWAD) 1001 such as a global session resource manager, which is itself a non-limiting example of a session resource manager.

FIG. 3 is a functional block diagram illustrating at least a portion of an exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

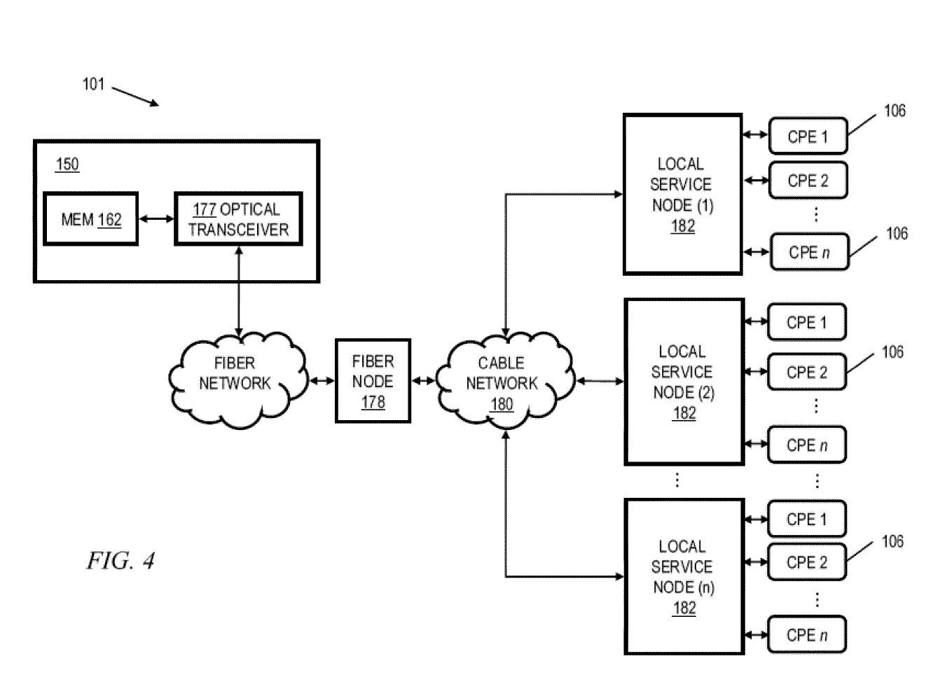

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., traditional audio, traditional (as distinguished from IPTV) video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS channels and associated protocols (e.g., DOCSIS 1.x, 2.0. or 3.0). The OpenCable™ Application Platform (OCAP) 1.0, 2.0, 3.0 (and subsequent) specification (Cable Television Laboratories Inc.) provides for exemplary networking protocols both downstream and upstream, although the invention is in no way limited to these approaches. All versions of the DOCSIS and OCAP specifications are expressly incorporated herein by reference in their entireties for all purposes. One or more aspects of embodiments of the invention are implemented for IPTV video in, for example, TWC TV®, a registered trademark of Time Warner Inc., applications, although embodiments of the invention are not limited to this implementation.

Furthermore in this regard, DOCSIS is an international telecommunications standard that permits the addition of high-speed data transfer to an existing cable TV (CATV) system. It is employed by many cable television operators to provide Internet access (cable Internet) over their existing HFC infrastructure. Use of DOCSIS to transmit data (including IPTV) on an HFC system is one non-limiting exemplary context associated with one or more embodiments. However, one or more embodiments are generally applicable to IPTV, regardless of what kind of functionality is employed.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server (MAS) 104A, Internet Protocol Video Services (IPVS) 104B (an MAS equivalent for TWC TV® applications), and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more DHCP server(s) 3304 can also be located where shown or in different locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number of CPE 106 per node 182 may be different than the number of nodes 182.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

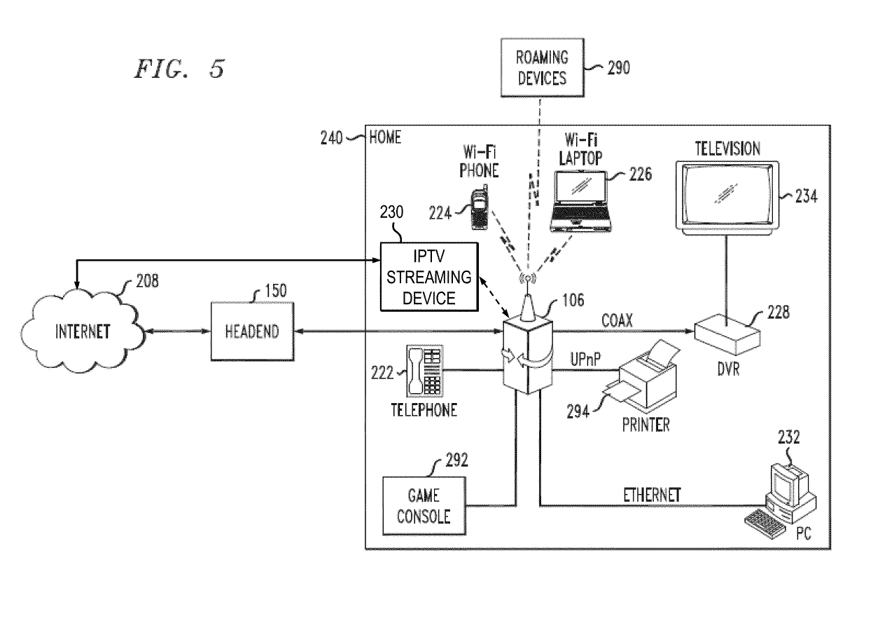

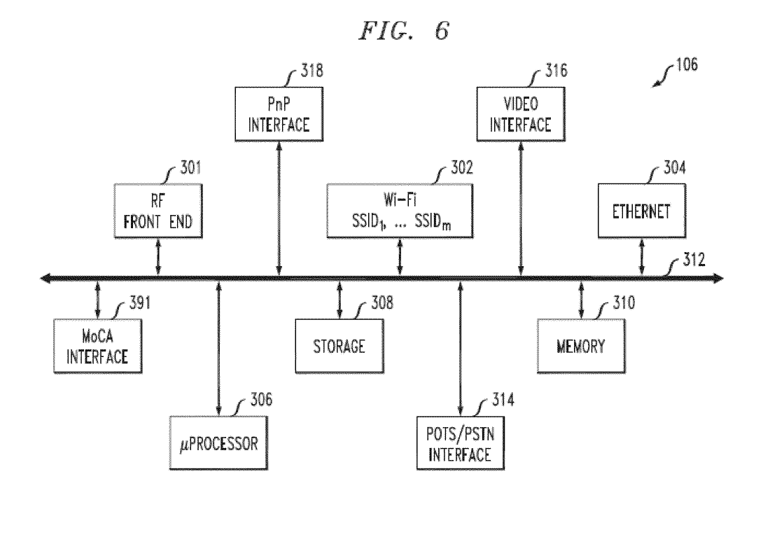

Reference should now be had to FIG. 5, which presents a block diagram of a premises network interfacing with a head-end of an MSO or the like, providing Internet access, traditional cable television (QAM) and/or IPTV. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like.

CPE 106 includes an advanced wireless gateway which connects to a head-end 150 or other hub of a network, such as a video content network of an MSO or the like. The head-end is coupled also to an internet (e.g., the Internet) 208 which is located external to the head-end 150, such as via an Internet (IP) backbone or gateway (not shown).

The head-end is, in the illustrated embodiment, coupled to multiple households or other premises, including the exemplary illustrated household 240. In particular, the head-end (for example, a cable modem termination system 156 thereof) is coupled via the aforementioned HFC network and local coaxial cable or fiber drop to the premises, including the CPE 106. The exemplary CPE 106 is in signal communication with any number of different devices including, for example, a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example over a universal plug and play (UPnP) interface, an IPTV streaming device 230 (e.g., Roku, or the like) and/or a game console 292; for example, over a multimedia over coax alliance (MoCA) interface, Ethernet, or other wired or wireless communication connection. Game console 292 is one example of an IPTV streaming device that could be used to watch IPTV in accordance with aspects of the invention. An IPTV streaming device 230 on which one or more embodiments are to be practiced can be connected to the Internet in many ways; an HFC network providing high-speed IP data in addition to traditional video content is merely one non-limiting exemplary embodiment. IPTV streaming device 230, like game console 292, could be connected to CPE 106 by, for example, Ethernet, Wi-Fi, or MoCA (e.g. via a MoCA-to-Ethernet bridge). All types of IPTV streaming devices or game consoles may not necessarily be capable of connection via all of Ethernet, Wi-Fi, and MoCA. Moreover, an IPTV streaming device 230 may, in one or more embodiments, be connected directly with the television 234, either via a wired or wireless connection (not explicitly shown, but implied). Some embodiments employ a Microsoft Xbox console as game console 292. Some embodiments are used only with traditional cable television services or other traditional content delivery services (e.g., fiber optic). Some embodiments that are directed to IPTV involve consumption of IPTV by devices other than, or in addition to, gaming consoles.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head-end over the interposed coax (and/or other, e.g., fiber) bearer medium. The signals include e.g., IPTV or other Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240. Again, the depicted example is non-limiting; some embodiments are directed only to traditional video delivery (non-IPTV); some embodiments are directed only to IPTV; and some embodiments are directed to both.

Any number of different data flows may occur within the network depicted in FIG. 5. For example, the CPE 106 may exchange digital telephone signals from the head-end which are further exchanged with the telephone unit 222, the Wi-Fi phone 224, or one or more roaming devices 290. The digital telephone signals may be IP-based, such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head-end 150 which is further exchanged with the Wi-Fi laptop 226, the PC 232, one or more roaming devices 290, the gaming console 292, or other device. CPE 106 may also receive digital programming that is forwarded to the DVR 228 or to the television 234. Programming requests and other control information may be received by the CPE 106 and forwarded to the head-end as well for appropriate handling.

FIG. 6 is a block diagram illustrating at least a portion of an exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled with a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random access memory (RAM) and storage unit 308 typically comprises a hard disk drive, an optical drive (e.g., CD-ROM or DVD), NAND flash memory, RAID (redundant array of inexpensive/independent disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, simple “cable box,” and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g. the Wi-Fi interface 302, Ethernet interface 304, MoCA interface 391, or plug-and-play (PnP) interface 318.

Additionally, the RF front end 301 modulates, encrypts/multiplexes as required, and transmits digital information for receipt by upstream entities such as the CMTS or a network server. This includes upstream commands from Xbox or other game console 292. In one or more embodiments, the Xbox or other game console does not communicate directly with the RF Front End 301; rather, it communicates with the RF Front End 301 over Ethernet 304 or Wi-Fi 302. In one or more embodiments that include an Xbox or other game console 292, upstream commands from the Xbox or other game console 292 are sent to the RF Front End over Ethernet 304 or Wi-Fi 302 and then upstream into the network, from the RF Front End 301, via DOCSIS or the like. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g. Internet protocol television (IPTV) devices, PCs, laptops, etc., as well as by roaming devices 290. In addition, the CPE 106 can be remotely managed (such as from the head-end 150, or another remote network agent) to support appropriate IP services.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and/or provision the CPE 106 from the cable head-end 150 or other remote network node via the cable modem (DOCSIS) interface. This control allows a remote user to configure and monitor the CPE 106 and home network.

The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

In addition to traditional “broadcast” content (e.g., video programming), the systems of FIGS. 1-6 may also be configured to deliver Internet data services (including IPTV) using the Internet protocol (IP), although other protocols and transport mechanisms of the type well known in the digital communication art may be substituted. The IP packets are typically transmitted on RF channels that are different than the RF channels used for the broadcast traditional video and audio programming, although this is not a requirement. The CPE 106 are each configured to monitor the particular assigned RF channel (such as via a port or socket ID/address, or other such mechanism) for IP packets intended for the subscriber premises/address that they serve. Again, it bears repeating that one or more embodiments are applicable to traditional cable television using QAMs, to other kinds of video content networks (e.g., fiber optic) and/or to internet protocol television (IPTV) delivered over any kind of IP network to any kind of IP device (a gaming console is one non-limiting example of a device that facilitates viewing IPTV)—wherever both broadcast content and video on demand (VOD) are available.

For viewing live television, electronic program guides (EPGs) provide viewers of broadcast media content (e.g., television, and the like) with continuously updated listings, sometimes referred to as “rolling listings,” of broadcast programming or scheduling information for current programming, often with forward scrolling capability to display upcoming programming information; some guides may also feature backward scrolling capability for displaying previously aired programming information. The skilled artisan will be familiar with EPG data and EPG servers per se as described, for example, in U.S. Patent Application Publication No. 2014/0282772 to David Chen et al., the complete disclosure of which is expressly incorporated herein by reference in its entirety for all purposes.

Non-interactive electronic program guides, considered one form of an EPG, are commonly available for television and comprise a digitally displayed, non-interactive menu of program scheduling information shown by a content (e.g., cable or satellite television) provider to its viewers/subscribers on a dedicated channel. Specifically, by tuning into an EPG channel, a listing is typically displayed that includes current and upcoming television programming information for all available channels offered by a given content provider. A typical EPG provides broadcast program information covering television listings for the next seven to fourteen days, although embodiments of the present invention are not restricted to any specific time period.

A more modern form of the EPG is an interactive program guide (IPG). An IPG allows viewers/subscribers the ability to navigate scheduling information menus interactively, selecting and discovering programming by time, title, station, genre, or other characteristics, using an input device such as a keypad, computer keyboard, television remote control device, game console controller, or the like. The interactive menus of the IPG are generated entirely within local receiving or display equipment using raw scheduling data sent by individual broadcast stations or centralized scheduling information providers. For television, IPG support is built into almost all modern receivers for digital cable, digital satellite, and over-the-air digital broadcasting.

Data to populate an EPG may be obtained from a media distribution source (e.g., through Tribune Media Services (TMS)) over the Internet or other network, either for a fee or free of charge, and implemented on equipment connected directly or through a computer to the Internet, although other sources for obtaining the data used to populate the EPG are similarly contemplated by embodiments of the invention. Television-based IPGs, in conjunction with Programme Delivery Control (PDC) technology (specified by the standard ETS 300 231 (ETSI EN 300 231), published by the European Telecommunications Standards Institute (ETSI)), can also facilitate the selection of programs for recording with digital video recorders (DVRs).

Conventionally, a program guide (e.g., EPG) including listings of live television programming, and listings of VOD content appear as two distinct sets of data that are managed in different environments on separate servers, and there is no connection between the two sets of data. One or more aspects of the present disclosure beneficially exploit the realization that a significant portion of the content broadcast on live television comprises re-runs of program content that is already available on demand. Thus, one or more embodiments of the invention advantageously provide a seamless integration of live content listings with available on-demand content through an enhanced EPG so as to provide viewers/subscribers with a mechanism for easily managing the viewing of live broadcast assets (i.e., programs) and on-demand assets through a single user interface.

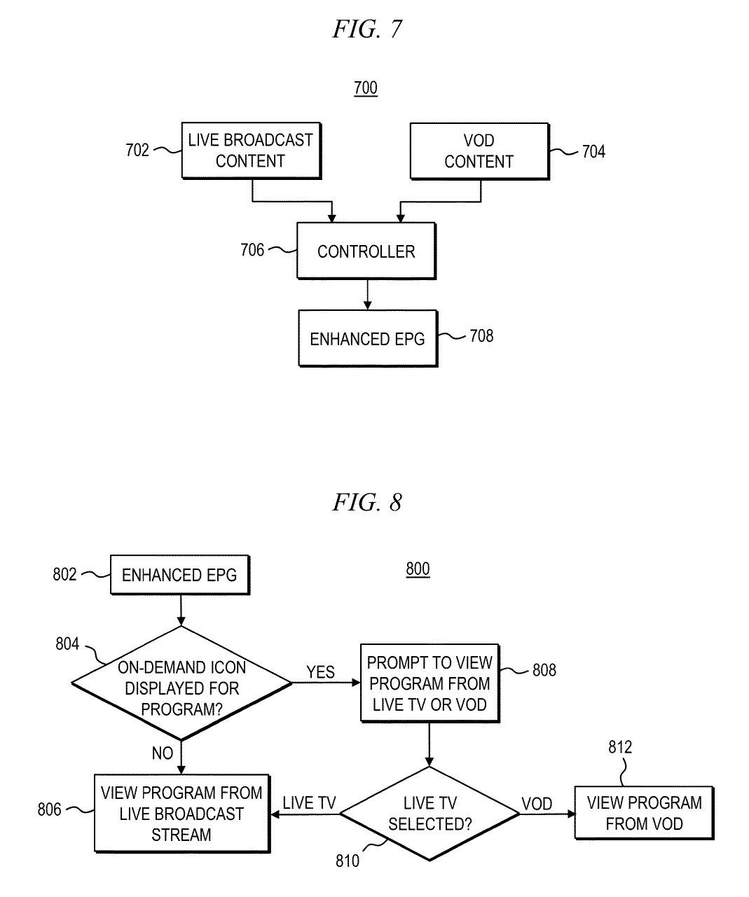

With reference now to FIG. 7, at least a portion of an illustrative system 700 is shown for generating an enhanced EPG with on-demand cross-references, according to an embodiment of the invention. The exemplary system 700 comprises a first database 702, which includes live broadcast content, and a second database 704, which includes VOD content. The two databases 702, 704 will likely reside in different locations, for example, in a head-end, regional data center, and/or national data center of a content delivery network, although embodiments of the invention do not preclude the two databases from residing proximate to one another. Information (e.g., in the form of a program listing or the like) corresponding to assets in the live broadcast content database 702 and information corresponding to assets in the VOD content database 704 are supplied as inputs to a controller 706. The controller 706 is configured to generate an enhanced EPG 708 which seamlessly integrates live broadcast assets with the VOD assets.

Program listings for the live broadcast content 702 may be generated in a manner consistent with the generation of listing information in a conventional EPG. The controller 706, in one or more embodiments, is configured to compare the information relating to the live broadcast assets and the information relating to the VOD assets. Using the information describing the live broadcast assets and VOD assets, when the controller 706 finds an asset in the live broadcast content database 702 that matches a corresponding asset in the VOD content database 704, the controller, in one or more embodiments, flags the VOD asset in a prescribed manner (e.g., generating a cross-reference table or the like which maps the live broadcast asset to its matching VOD asset) and places a visual indication associated with the live broadcast asset in the enhanced EPG 708 notifying the viewer that the corresponding live broadcast content is also available for viewing on demand; that is, the viewer is provided with a choice, via the enhanced EPG, as to whether a desired program/asset is to be viewed from the live broadcast stream or from a VOD stream.

The visual indication, in one or more embodiments, is displayed in the form of an icon or other indicator placed next to each program listing having corresponding on-demand content, for example on the group guide or on an information banner in the enhanced EPG 708. The icon may, in one or more embodiments, contain an active link which, when selected (e.g., by a user), is configured to initiate a VOD session streamed to a television or other CPE device of the user so that the user can view the selected program as a VOD asset rather than as a live broadcast asset.

With regard to live broadcast assets, program data for live television is supplied by a broadcast content provider, such as, for example Tribune Media Services. This data is placed into a format in which a group guide is created based on an individual subscriber's channel lineup. Specifically, a client application is initiated which calls one or more corresponding content servers to obtain program information. The servers will know what program information the client is entitled to (e.g., based on subscriber login information, etc.) and thereby creates a channel lineup displaying live programming information relating to the available channels, including what program is currently running and what program will be airing next for each channel.

With regard to VOD assets, VOD content providers prepare a package including a video file and metadata describing the video file (e.g., title, format, licensing window, run time/duration, etc.). A “catcher” or alternative receiving module at the MSO (e.g., Time Warner Cable) is configured to receive the package from the VOD provider and provision the video file onto a video server (e.g., a content delivery network (CDN)) and provision the metadata file into a database of VOD assets describing where the VOD asset is located, among other functions.

FIG. 8 is a flow diagram depicting at least a portion of an exemplary program content selection methodology 800, according to an embodiment of the invention. As apparent from FIG. 8, the method 800 utilizes an enhanced EPG in step 802 to determine, in step 804, whether a given live broadcast asset has an on-demand asset associated therewith as indicated by an icon associated with the live broadcast asset displayed in the EPG. When no icon is displayed, indicating that there is no corresponding on-demand asset available for that program, the program is viewed from the live broadcast stream in step 806 during its scheduled time. If the program has already begun, the viewer picks up the program already in progress. Alternatively, when an icon is displayed indicating that the selected live broadcast asset has an available on-demand asset corresponding thereto, step 808 prompts the viewer to choose whether the selected program content is to be viewed from the live broadcast stream or whether it is to be viewed from the VOD stream.

When it is determined, in step 810, that a live viewing option has been selected, the program is viewed from the live broadcast stream in step 806. Alternatively, when step 810 determines that a VOD option has been selected, the program is viewed from the VOD stream in step 812. Preferably, in one or more embodiments, the enhanced EPG may be configured such that the icon contains an active link to the corresponding on-demand asset, thereby eliminating the need to present the viewer with a prompt; that is, step 808 may be eliminated. Thus, when the viewer selects (e.g., clicks on) the on-demand icon, for example using an input device (e.g., remote control device, keypad, computer keyboard, game console, etc.), an on-demand session is initiated and the selected program content begins streaming to a device of the viewer (e.g., television, smart phone, and the like) from a VOD content source.

The ability to stream on-demand content from a separate server using the enhanced EPG in accordance with one or more embodiments of the invention provides a viewer with beneficial features not currently achievable using a standard EPG. By way of example only and without limitation, the enhanced EPG with on-demand cross-references, according to one or more aspects of the disclosure, provides viewers/subscribers with the ability to restart a selected live broadcast program which is already in progress or has already ended. The program may be restarted from the beginning or from another prescribed point in time, as may be selected by the viewer.

The enhanced EPG with on-demand cross-references, according to one or more aspects of the disclosure, provides viewers/subscribers with the ability to browse through the live broadcast listing to search for future programs that have corresponding VOD assets available. This feature, which may be referred to as a “look-ahead” function, allows the viewer to control whether to wait for a selected live broadcast asset to be aired at its scheduled date and time by viewing the program from the live broadcast stream, or whether to immediately begin viewing the program as an on-demand asset from the VOD stream.

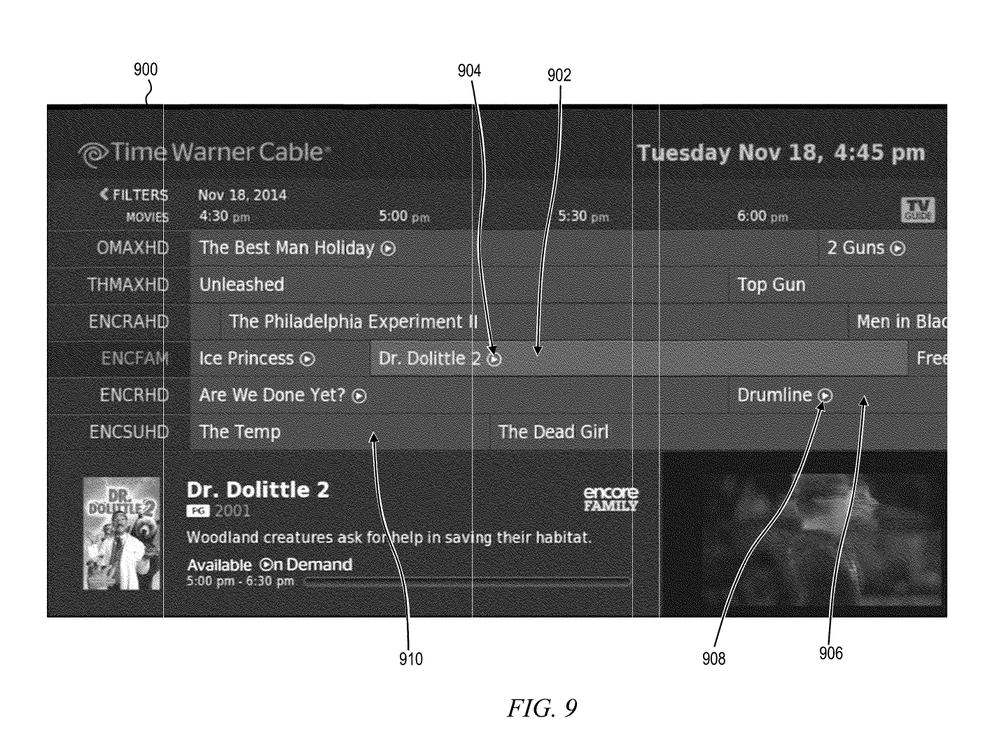

FIG. 9 is a screen shot conceptually depicting an exemplary EPG 900 with on-demand cross-references, according to an embodiment of the invention. It is to be appreciated that embodiments of the invention are not limited to any specific format for displaying programming information in the EPG, nor is the invention limited to the type of information displayed in the EPG. With reference to FIG. 9, the EPG 900 in this illustrative embodiment is divided into a channel information portion (left side), which displays channel name (e.g., HBOSHD) and number (e.g., 653), and a program listing portion (right side), which shows a grid of programs and their corresponding air times for each of the channels displayed. In this illustrative embodiment, program listings for channels 651 through 656 are displayed for the time period 8:00 pm through 10:00 pm. A viewer may display additional channels and/or program times by navigating the EPG using prescribed keys (e.g., up, down left and right arrow keys) on the input device in a conventional manner, as will be known to those skilled in the art.

As apparent from FIG. 9, a selected live broadcast program 902 in the EPG 900 may have an icon 904 associated therewith indicating that this program content is also available as an on-demand asset. Thus, the viewer has a choice of watching the live version of the program 902 from the selected channel (e.g., 653) already in progress, or watching the on-demand version of the program content from its beginning, or at any other desired point. The EPG 900 displays other programs, such as program 906, with a corresponding icon 908 indicating that the program content is also available on demand. In the case of program 906, which has not yet started, the viewer may decide to start watching the on-demand version of the program content immediately rather than waiting for the live version of the program to air on channel 653. Likewise, the EPG 900 displays programs, such as program 910, which do not have icons associated therewith; the absence of an associated icon indicating that the live broadcast asset does not have a corresponding on-demand asset available for viewing. In this scenario, such programs would need to be viewed live at their respective scheduled broadcast times and cannot be viewed on demand.

In accordance with aspects of the disclosure, a unique identifier is associated with each of the on-demand assets to facilitate mapping of the on-demand assets to corresponding live broadcast assets. These unique identifiers, in one or more embodiments, may be sent to a broadcast content provider (e.g., Tribune Media Services) which enables the broadcast content provider to supply a more robust set of metadata describing each of the broadcast assets. This metadata is used to enhance VOD applications by generating a richer VOD content library.

Although not limited to any specific identification means for cataloging on-demand assets, one or more embodiments of the invention make use of the Entertainment Identifier Registry (EIDR) to provide a unique identifier associated with each of the on-demand assets. The EIDR is a universal unique identifier system for motion pictures and television assets. EIDR, which is promoted by leading companies including, but not limited to, Time Warner Cable, Disney/ABC Television Group, MovieLabs, NBCUniversal, Paramount Pictures, Rovi Corporation, Turner Broadcasting System, Viacom and Warner Brothers, provides global unique identifiers for an entire range of audiovisual object types that are relevant to entertainment commerce, including, for example, top level titles, edits, and DVDs, to encodings, clips and mash-ups.

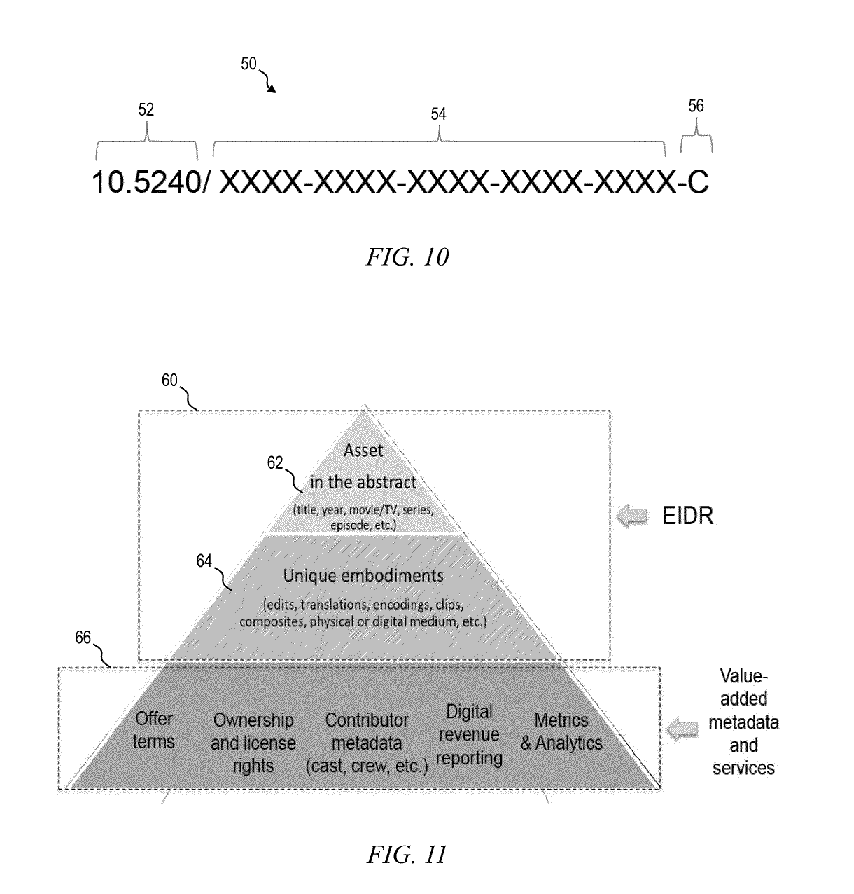

FIG. 10 conceptually depicts an exemplary EIDR identifier 50, suitable for use in conjunction with one or more embodiments of the invention. As set forth in the document entitled “EIDR System Version 2.0: Data Fields Reference,” Entertainment ID Registry Association, April 2014, the disclosure of which is incorporated herein by reference in its entirety for all purposes, the EIDR identifier 50 is formatted comprising a first data field 52, which is defined as a standard prefix for EIDR, a second data field 54, which is defined as a unique suffix for each asset in the EIDR, following the first data field, and a third data field 56, which is defined as a base 36 check digit, following the second data field as shown. The suffix 54 includes 20 hexadecimal digits assigned by the EIDR to uniquely identify discrete content and video services maintained in the registry. Assets are comprised of the following base object types: Movie, TV, Web, Short, and Supplemental. The EIDR is part of a larger ISO-approved initiative called Digital Object Identifier (DOI), which is supported by the International DOI Foundation. DOI is, in turn, an implementation of the Handle System created by the Corporation for National Research Initiatives.

The EIDR registry associates a content handle with a minimal set of metadata required to maintain uniqueness and avoid duplication. According to the EIDR specification, the most fundamental type of EIDR record is known as an abstraction as the concept of an original work with no particular manifestation. An asset in the abstract includes enough metadata to establish its identity (e.g., title, date or year of release, country of origin, original language, movie/TV, series, episode, etc.). Once the root creative content records are established, EIDR registrants are able to create additional unique embodiments that derive from the root. This forms a hierarchical tree in EIDR that provides valuable content relationships for its users.

FIG. 11 conceptually depicts one way in which EIDR may be used to enable scalable content services, which is suitable in conjunction with one or more embodiments of the invention. Specifically, with reference to FIG. 11, the EIDR 60, which comprises assets in the abstract 62 (e.g., title, year, movie/TV, series, episode, etc.) and unique embodiments 64 (e.g., edits, translations, encodings, clips, composites, physical or digital medium, etc.) branching out from the assets in the abstract, is represented as a root in a hierarchical tree. Value-added metadata and services 66, which may include, for example, offer terms, ownership and license rights, contributor metadata (e.g., cast, crew, etc.), digital revenue reporting, metrics and analytics, etc., branch out further from the unique embodiments 64. Thus, the EIDR provides a common link for an unlimited number of value-added services. There are also pre-cursors to EIDR, where various standards organizations have attempted to establish universal video content registries with their own unique identifiers. It is to be appreciated that embodiments of the invention are suitable for use with any mechanism for identifying and matching live TV content with corresponding VOD content.

Thus, one or more embodiments are applicable in a variety of contexts where live TV and VOD are available. The listings for each are typically found in different environments on different servers. Live TV listings are typically based on data from a service such as Gracenote, Inc. (formerly Tribune Media Services). A grid guide can be prepared from such data and a subscriber's channel lineup. Each asset may be identified, for example, via a so-called TMS Unique ID from Gracenote. One or more servers “know” who the subscriber is based his or her cable modem and/or login details.

One or more embodiments are useful when a unique identifier for a piece of content is the same for both broadcast and VOD, or when different identifiers for VOD and broadcast can be correlated. Exemplary identifiers include the TMS Unique ID or EIDR; however, VOD and broadcast assets can also be matched via one or more of title, release date, original air date, and/or other identifying characteristics.

It should be noted that one or more embodiments differ from prior art Start Over® or Look Back® services (registered marks of TIME WARNER CABLE ENTERPRISES LLC, New York, N.Y., USA), or Catch-up and Quick Clips VOD applications, at least in that those services are tied to a specific license window for live broadcast content. For instance, the Start Over® license window begins when a broadcast program starts airing live and it extends until 2.5 times the program length after the live broadcast ends. Thus, for a thirty-minute TV program, the Start Over® license window ends 75 minutes after the live broadcast ends. Look Back® rights typically extend 48-72 hours in the past after the live broadcast ends, but still require airing of the live broadcast program for the VOD application to be enabled. In the case of Start Over® and Look Back® services, content is typically acquired locally, meaning that the MSO (e.g., TWC) records the content from the live broadcast (i.e., as the program is airing) and provisions the content for playback from the VOD systems. In accordance with one or more embodiments, content available through the EPG by selecting an icon indicating that a given live broadcast asset has an available on-demand asset linked thereto follows a normal VOD workflow, meaning that the content is produced, packaged with metadata and pitched to the MSO as a VOD package (video, metadata and related artifacts like trailers and box art) thru the normal VOD process.

By contrast to Start Over®, Look Back®, Catch-up and Quick Clips VOD applications, embodiments of the invention are not tied to the live broadcast license window, but rather are tied to a VOD license window; that is, in the enhanced EPG according to one or more embodiments of the invention, the streaming of a VOD asset is independent of the airing of a corresponding live broadcast asset. Thus, in one or more embodiments, if the VOD license window is sixty days, for example, the program listing will continue to be annotated with an icon in the EPG anytime the program airs live during the sixty-day period, indicating that the selected live broadcast asset has an available on-demand asset corresponding thereto during that period. When the prescribed VOD license window expires, the program listing will no longer be annotated with an icon in the EPG indicating that the selected live broadcast asset has an available on-demand asset linked thereto. Additionally, one or more embodiments enable a user to scroll forward in time, beyond presently airing programs, to find programs available in the VOD catalog that will air live at a prescribed time in the future.

It is to be appreciated that, unlike Start Over and Look Back features, for instance, embodiments of the invention do not record live broadcast programs. Rather, embodiments of the invention cross-reference what is available through live broadcast programming, as shown on the EPG, with a catalog of VOD assets. Thus, the visual indication placed adjacent to a given live broadcast program in the enhanced EPG represents that there is a corresponding VOD asset already available for viewing, independently of whether or not the given live broadcast program has aired.

Given the discussion thus far, it will be appreciated that, in general terms, an exemplary method, according to an aspect of the invention, includes the step of obtaining, by a controller, a first set of information regarding live broadcast assets. The first set of information, in one or more embodiments, is obtained from a first database in operative communication with the controller. The first set of information may, in one or more embodiments, be included in an EPG or the like used for organizing and displaying live broadcast assets in a user-friendly manner. Another step includes obtaining, by the controller, a second set of information regarding on-demand assets. The second set of information, in one or more embodiments, is obtained from a second database in operative communication with the controller. The second set of information may, in one or more embodiments, be in the form of a VOD catalog which includes a listing of available on-demand assets. The method further includes the step of comparing, by the controller, the first and second sets of information to determine whether at least one of the live broadcast assets has a matching on-demand asset, and placing a visual indication associated with a listing of at least a given one of the live broadcast assets on a corresponding EPG. The visual indication is indicative that the given one of the live broadcast assets has a matching on-demand asset.

Given the discussion thus far, it will be appreciated that, in general terms, an exemplary apparatus for facilitating an enhanced electronic program guide with on-demand cross-references, according to an aspect of the invention, includes a memory, at least one processor coupled to the memory, and a non-transitory persistent storage medium. The storage medium contains instructions which, when loaded into the memory, configure the processor: to obtain a first set of information regarding live broadcast assets; to obtain a second set of information regarding on-demand assets; to compare the first and second sets of information to determine whether at least one of the live broadcast assets has a matching on-demand asset; and to place a visual indication associated with a listing of the at least one of the live broadcast assets on the enhanced electronic program guide. The visual indication is indicative that a given live broadcast asset has a matching on-demand asset.

### System and Article of Manufacture Details

Embodiments of the invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which, when executed, implement such step(s); that is to say, a computer program product including a tangible computer-readable recordable storage medium (or multiple such media) with computer-usable program code configured to implement the method steps indicated, when run on one or more processors. Furthermore, one or more embodiments of the invention or elements thereof can be implemented in the form of an apparatus (e.g., server, personal computer, gaming console) including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors (e.g., on the controller 706 of FIG. 7), or (iii) a combination of (i) and (ii); any of (i)-(iii) implement the specific techniques set forth herein, and the software modules are stored in a tangible computer-readable recordable storage medium (or multiple such media). The means do not include transmission media per se or disembodied signals per se. Appropriate interconnections via bus, network, and the like can also be included.

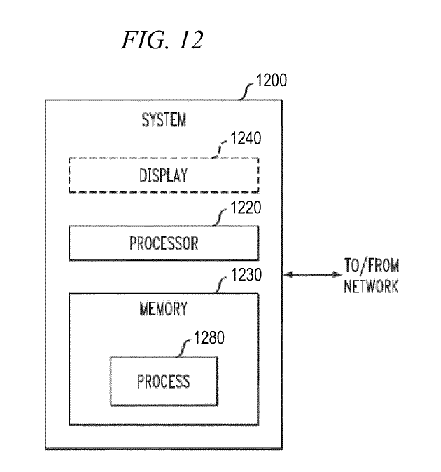

FIG. 12 is a block diagram of a system 1200 configurable for implementing at least some aspects of the invention, and is representative, for example, of one or more of the servers or personal computers shown in the figures. As shown in FIG. 12, memory 1230 configures the processor 1220 to implement one or more methods, steps, and functions (collectively, shown as process 1280 in FIG. 12). The memory 1230 could be distributed or local and the processor 1220 could be distributed or singular. Different steps could be carried out by different processors.

The memory 1230 could be implemented as an electrical, magnetic or optical memory, or any combination of these or other types of non-transient (e.g., persistent) storage devices. It should be noted that if distributed processors are employed, each distributed processor that makes up processor 1220 generally contains its own addressable memory space. It should also be noted that some or all of computer system 1200 can be incorporated into an application-specific or general-use integrated circuit. For example, one or more method steps could be implemented in hardware in an ASIC (application-specific integrated circuit) or FPGA (field-programmable gate array) rather than using firmware. Display 1240 is representative of a variety of possible input/output devices (e.g., keyboards, mice, and the like). Every processor may not have a display, keyboard, mouse or the like associated with it.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system (including, for example, system 1200, or the like), to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass a transmission medium or disembodied signal.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, for example, on a gaming console, a personal computer, or a virtualized or non-virtualized hardware server implementing one or more of the blocks/sub-blocks in FIGS. 1 through 8 (e.g., controller 706 in FIG. 7), and the like, and that such program may be embodied on a tangible computer readable recordable storage medium. As used herein, including the claims, unless it is unambiguously apparent from the context that only server software is being referred to, a “server” includes a physical data processing system (for example, system 1200 as shown in FIG. 12) running one or more server programs. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures (e.g. controller 706 in FIG. 7). The method steps can then be carried out using the distinct software modules of the system, as described above, executing on one or more hardware processors (e.g., one or more hardware processors of a gaming console; a personal computer; or a server) and utilizing intermediate network links and network nodes. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining, by a controller, a first set of information regarding live broadcast assets;
obtaining, by the controller, a second set of information regarding on-demand assets;
comparing, by the controller, the first and second sets of information to determine whether at least one of the live broadcast assets has a matching on-demand asset; and
placing a visual indication associated with a listing of the at least one of the live broadcast assets on a corresponding electronic program guide, the visual indication being indicative that the at least one of the live broadcast assets has a matching on-demand asset.

2. The method of claim 1, wherein the first set of information regarding live broadcast assets is obtained by the controller from a first database in operative communication with the controller, and the second set of information regarding on-demand assets is obtained by the controller from a second database in operative communication with the controller.

3. The method of claim 1, wherein the first and second databases are different.

4. The method of claim 1, further comprising configuring the visual indication to include an active link which, when selected by a user, initiates a video-on-demand (VOD) session through the electronic program guide whereby selected program content associated with the visual indication begins streaming to a device of the user from a VOD content source.

5. The method of claim 4, wherein the VOD session is initiated through the electronic program guide independently of airing a corresponding live broadcast asset.

6. The method of claim 1, further comprising:
assigning a unique identifier to each of at least a subset of the live broadcast assets; and
assigning a unique identifier to each of at least a subset of the on-demand assets;
wherein comparing the first and second sets of information comprises determining, for each of at least a subset of program listings in the electronic program guide corresponding to the live broadcast assets, whether the unique identifier assigned to a given one of the live broadcast assets matches the unique identifier assigned to a given one of the on-demand assets.

7. The method of claim 6, further comprising formatting the respective unique identifiers assigned to the live broadcast assets and the on-demand assets according to an Entertainment Identifier Registry (EIDR) standard.

8. The method of claim 6, further comprising formatting the respective unique identifiers assigned to the live broadcast assets and the on-demand assets according to a Tribune Media Services (TMS) Unique ID standard.

9. The method of claim 1, wherein the visual indication is associated with a listing of at least one of the live broadcast assets scheduled to air at a prescribed time in the future.

10. The method of claim 1, wherein the visual indication is associated with a listing of at least one of the live broadcast assets that is currently in progress.

11. The method of claim 1, wherein comparing the first and second sets of information comprises determining, for each of at least a subset of program listings in the electronic program guide corresponding to the live broadcast assets, whether at least one of a title, a release date, and an original air date of a given one of the live broadcast assets matches at least a corresponding one of a title, a release date, and an original air date of a given one of the on-demand assets.

12. The method of claim 1, wherein the second set of information comprises a catalog of on-demand assets.

13. An apparatus for facilitating an enhanced electronic program guide with on-demand cross-references, the apparatus comprising:
a memory;
at least one processor coupled to said memory; and
a non-transitory persistent storage medium which contains instructions which, when loaded into said memory, configure said at least one processor:
to obtain a first set of information regarding live broadcast assets;
to obtain a second set of information regarding on-demand assets;
to compare the first and second sets of information to determine whether at least one of the live broadcast assets has a matching on-demand asset; and
to place a visual indication associated with a listing of the at least one of the live broadcast assets on the enhanced electronic program guide, the visual indication being indicative that the at least one of the live broadcast assets has a matching on-demand asset.

14. The apparatus of claim 13, wherein said instructions, when loaded into said memory, further configure said at least one processor to be operative to obtain the first set of information regarding live broadcast assets from a first database in operative communication with the at least one processor and to obtain the second set of information regarding on-demand assets from a second database in operative communication with the at least one processor.

15. The apparatus of claim 14, wherein the first and second databases are different.

16. The apparatus of claim 13, wherein said instructions, when loaded into said memory, further configure said at least one processor to be operative to configure the visual indication to include an active link which, when selected by a user, initiates a video-on-demand (VOD) session through the electronic program guide whereby selected program content associated with the visual indication begins streaming to a device of the user from a VOD content source.

17. The apparatus of claim 16, wherein the VOD session is initiated through the electronic program guide independently of airing a corresponding live broadcast asset.

18. The apparatus of claim 13, wherein said instructions, when loaded into said memory, further configure said at least one processor to be operative:
to assign a unique identifier to each of at least a subset of the live broadcast assets; and
to assign a unique identifier to each of at least a subset of the on-demand assets;
wherein comparing the first and second sets of information comprises determining, for each of at least a subset of program listings in the electronic program guide corresponding to the live broadcast assets, whether the unique identifier assigned to a given one of the live broadcast assets matches the unique identifier assigned to a given one of the on-demand assets.

19. The apparatus of claim 18, wherein said instructions, when loaded into said memory, further configure said at least one processor to be operative to format the respective unique identifiers assigned to the live broadcast assets and the on-demand assets according to an Entertainment Identifier Registry (EIDR) standard.

20. The apparatus of claim 18, wherein said instructions, when loaded into said memory, further configure said at least one processor to be operative to format the respective unique identifiers assigned to the live broadcast assets and the on-demand assets according to a Tribune Media Services (TMS) Unique ID standard.

21. The apparatus of claim 13, wherein the visual indication is associated with a listing of at least one of the live broadcast assets scheduled to air at a prescribed time in the future.

22. The apparatus of claim 13, wherein the visual indication is associated with a listing of at least one of the live broadcast assets that is currently in progress.

23. The apparatus of claim 13, wherein said instructions, when loaded into said memory, further configure said at least one processor to be operative to compare the first and second sets of information by determining, for each of at least a subset of program listings in the electronic program guide corresponding to the live broadcast assets, whether at least one of a title, a release date, and an original air date of a given one of the live broadcast assets matches at least a corresponding one of a title, a release date, and an original air date of a given one of the on-demand assets.

24. The apparatus of claim 13, wherein the second set of information comprises a catalog of on-demand assets.
